(19) United States
(12) Patent Application Publication
(10) Pub. No.: US 2023/0213761 A1
(43) Pub. Date: Jul. 6, 2023

(54) DISPLAY SYSTEMS WITH GRATINGS ORIENTED TO REDUCE APPEARANCES OF GHOST IMAGES

(71) Applicant: Meta Platforms Technologies, LLC, Menlo Park, CA (US)

(72) Inventors: Wai Sze Tiffany LAM, Lynnwood, WA (US); Yang Yang, Redmond, WA (US); Dominic Meiser, Bothell, WA (US); Wanli Chi, Sammamish, WA (US)

(73) Assignee: Meta Platforms Technologies, LLC, Menlo Park, CA (US)

(21) Appl. No.: 17/569,349

(22) Filed: Jan. 5, 2022

(51) Int. Cl. G02B 27/00; G02B 27/01; G02B 27/42; F21V 8/00; G02C 5/14; G02C 11/00

(52) U.S. Cl. CPC G02B 27/0037; G02B 6/005; G02B 6/0023; G02B 27/0172; G02B 27/4205; G02C 5/14; G02C 11/10; G02B 2027/0178

(57) ABSTRACT

According to examples, a display system may include a wearable eyewear arrangement that may include a lens assembly having a projector to propagate display light associated with an image. The lens assembly may also include a waveguide for propagating the display light to an eyebox, in which the waveguide may include a plurality of gratings through which the first display light is sequentially propagated and in which at least one of the plurality of gratings is oriented to propagate the display light to a next grating while reducing an appearance of a ghost image of the image on the eyebox.

### TECHNICAL FIELD

This patent application relates generally to display systems, and more specifically, to display systems that include a plurality of gratings, in which at least one of the plurality of gratings is oriented to reduce, e.g., prevent or minimize, an appearance of a ghost image on an eyebox.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted device (HMD), such as a wearable eyewear, a wearable headset, or eyeglasses. In some examples, the head-mounted device (HMD) may employ a first projector and a second projector to direct light associated with a first image and a second image, respectively, through one or more intermediary optical components at each respective lens, to generate “binocular” vision for viewing by a user. Providing quality images for the user may, however, be challenging.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIG. 3 is a perspective view of a near-eye display in the form of a pair of glasses, according to an example.

FIG. 4 illustrates a schematic diagram of an optical system in a near-eye display system, according to an example.

FIG. 5 illustrates a diagram of a waveguide, according to an example.

FIG. 6A illustrates a diagram of a waveguide including an arrangement of volume Bragg gratings (VBGs), according to an example.

FIG. 6B shows a k-vector diagram corresponding to the propagation of light through the first middle grating and the second middle grating depicted in FIG. 6A.

FIG. 6C shows an enlarged cross-sectional view of a portion of the first middle grating depicted in FIG. 6A.

FIG. 7A illustrates a diagram of a waveguide including an arrangement of volume Bragg gratings (VBGs), according to an example.

FIG. 7B shows a k-vector diagram corresponding to the propagation of light through the first middle grating and the second middle grating depicted in FIG. 7A.

FIG. 7C shows an enlarged cross-sectional view of a portion of the first middle grating depicted in FIG. 7A.

FIG. 8 illustrates a block diagram of a back-mounted arrangement for a display system in a shape of eyeglasses, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Some display systems, such as, AR-based head-mounted devices and/or eyewear devices, employ waveguides having multiplexed gratings to propagate light associated with an image from a projector to an eyebox. In some instances, stray light from a projector or one or more intermediary optical components of display systems may create crosstalk and/or reach the eyes of the user before or after it is intended to, thereby creating visual artifacts, such as ghost images. In some examples, the ghost image may be a false image version of the image, an out-of-focus version of the image, a distorted version of the image, etc., or other type of artifact arising in propgation of light through multiplexed gratings. The appearance of the ghost image may affect the quality of the image displayed to a user and thus, may negatively impact a user’s experience with such display systems. Furthermore, the user may experience poor visual acuity and significant visual discomfort, which often results in dizziness, eye fatigue, or other side effects.

Disclosed herein are systems and apparatuses that may provide display systems in which the appearance of artifacts, such as ghost images, may be reduced, e.g., prevented or minimized, on the display systems. The display systems (e.g., AR-based head-mounted device (HMD) or eyewear) described herein may have a lens assembly that includes a waveguide for propagating light from a projector to an eyebox. The light may be associated with an image that may be viewable by a user of the display system when the image is displayed on the eyebox. The waveguide may include a plurality of gratings through which the display light may sequentially be propagated. In addition, at least one of the plurality of gratings may be oriented to propagate the display light to a next grating while reducing an appearance of a ghost image of the image on the eyebox.

Particularly, for instance, a z-direction of at least one of the plurality of gratings may be oriented to cause the appearance of the ghost image on the eyebox to be reduced. By way of particular example, the z-direction of the at least one of the plurality of gratings may be a direction that is opposite a normal z-direction of the at least one of the plurality of gratings. The term “opposite” may mean an opposite sign, e.g., a negative or positive value. The normal z-direction may be defined as a z-direction at which a ghost image appears.

The plurality of gratings described herein may include an input grating, a first middle grating, a second middle grating, and an output grating. In some examples, the z-direction of the first middle grating may be oriented to reduce the appearance of the ghost image. In some examples, the z-direction of the second middle grating may be oriented to reduce the appearance of the ghost image. In some examples, the z-directions of both the first middle grating and the second middle grating may be oriented to reduce the appearance of the ghost image. In these examples, the z-directions of the both the first middle grating and the second middle grating may be oriented to the same direction with respect to each other.

The plurality of gratings described herein may be associated with a volume Bragg grating (VBG)-based waveguide display device. As used herein, a volume Bragg grating (VBG) may refer to a substantially and/or completely transparent optical device or component that may exhibit a periodic variation of refractive index (e.g., using a volume Bragg grating (VBG)). As discussed further in the examples below, one or more volume Bragg gratings (VBGs) may be provided with or integrated within a waveguide component of a display system. As used herein, a waveguide may be any optical structure that propagates a variety of signals (e.g., optical signals, electromagnetic waves, sound waves, etc.) in one or more directions. Employing principles of physics, information contained in such signals, may be directed using any number of waveguides or similar components.

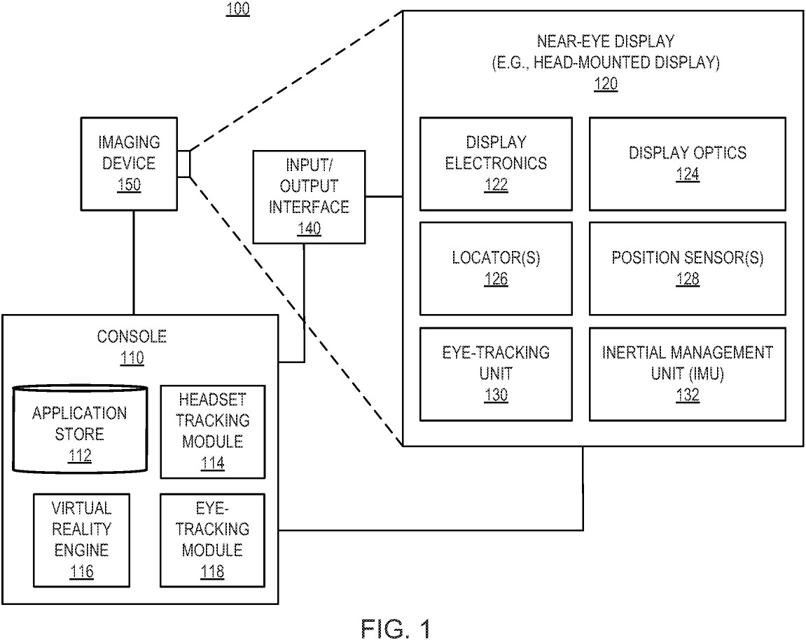

FIG. 1 illustrates a block diagram of an artificial reality system environment 100 including a near-eye display, according to an example. As used herein, a “near-eye display” may refer to a device (e.g., an optical device) that may be in close proximity to a user’s eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular HMD) or both eyes (for binocular HMDs). Also, as used herein, an “eyebox” may be a two-dimensional box that may be positioned in front of the user’s eye from which a displayed image from an image source may be viewed.

In some examples, in a near-eye display system, light from a surrounding environment may traverse a “see-through” region of a waveguide display (e.g., a transparent substrate) to reach a user’s eyes. For example, in a near-eye display system, light of projected images may be coupled into a transparent substrate of a waveguide, propagate within the waveguide, and be coupled or directed out of the waveguide at one or more locations to replicate exit pupils and expand the eyebox.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

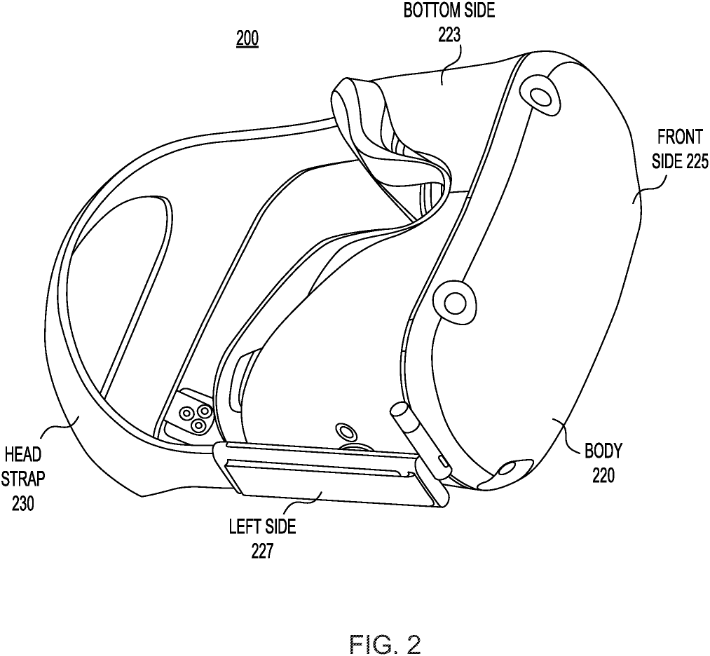

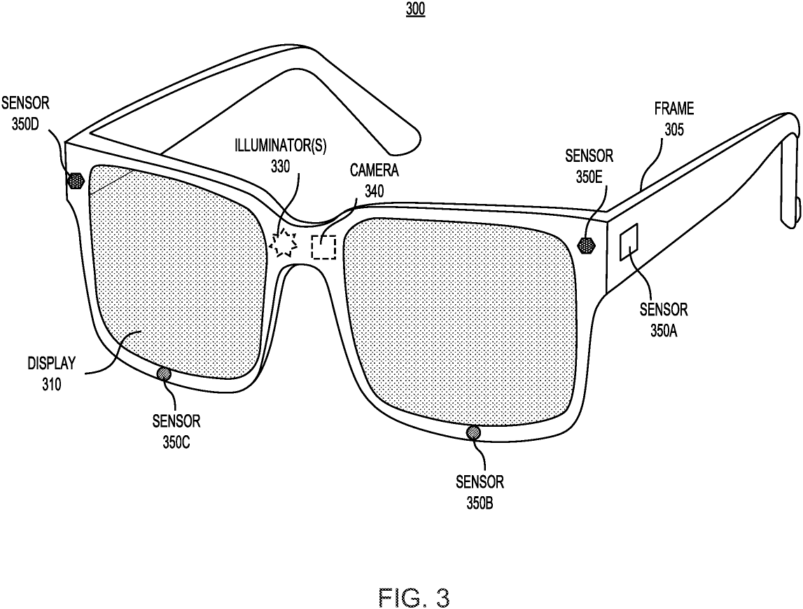

In some examples, the near-eye display 120 may be implemented in any suitable form-factor, including a HMD, a pair of glasses, or other similar wearable eyewear or device. Examples of the near-eye display 120 are further described below with respect to FIGS. 2 and 3. Additionally, in some examples, the functionality described herein may be used in a HMD or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset’s position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye-tracking unit 130 may include one or more eye-tracking systems. As used herein, “eye tracking” may refer to determining an eye’s position or relative position, including orientation, location, and/or gaze of a user’s eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user’s main line of sight), collect heuristics on the user interaction in the virtual reality (VR) media (e.g., time spent on any particular subject, object, or frame as a function of exposed stimuli), some other functions that are based in part on the orientation of at least one of the user’s eyes, or any combination thereof. In some examples, because the orientation may be determined for both eyes of the user, the eye-tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optical console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye-tracking module 118. Based on the received information, the virtual reality engine 116 may determine content to provide to the near-eye display 120 for presentation to the user.

In some examples, the eye-tracking module 118 may receive eye-tracking data from the eye-tracking unit 130 and determine the position of the user’s eye based on the eye tracking data. In some examples, the position of the eye may include an eye’s orientation, location, or both relative to the near-eye display 120 or any element thereof. So, in these examples, because the eye’s axes of rotation change as a function of the eye’s location in its socket, determining the eye’s location in its socket may allow the eye-tracking module 118 to more accurately determine the eye’s orientation.

In some examples, a location of a projector of a display system may be adjusted to enable any number of design modifications. For example, in some instances, a projector may be located in front of a viewer’s eye (i.e., “front-mounted” placement). In a front-mounted placement, in some examples, a projector of a display system may be located away from a user’s eyes (i.e., “world-side”). In some examples, a head-mounted display (HMD) device may utilize a front-mounted placement to propagate light towards a user’s eye(s) to project an image.

FIG. 2 illustrates a perspective view of a near-eye display in the form of a head-mounted display (HMD) device 200, according to an example. In some examples, the HMD device 200 may be a part of a virtual reality (VR) system, an augmented reality (AR) system, a mixed reality (MR) system, another system that uses displays or wearables, or any combination thereof. In some examples, the HMD device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the HMD device 200 for allowing a user to mount the HMD device 200 onto the user’s head. In some examples, the HMD device 200 may include additional, fewer, and/or different components.

In some examples, the HMD device 200 may present, to a user, media or other digital content including virtual and/or augmented views of a physical, real-world environment with computer-generated elements. Examples of the media or digital content presented by the HMD device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the HMD device 200.

In some examples, the HMD device 200 may include various sensors (not shown), such as depth sensors, motion sensors, position sensors, and/or eye tracking sensors. Some of these sensors may use any number of structured or unstructured light patterns for sensing purposes. In some examples, the HMD device 200 may include an input/output interface 140 for communicating with a console 110, as described with respect to FIG. 1. In some examples, the HMD device 200 may include a virtual reality engine (not shown), but similar to the virtual reality engine 116 described with respect to FIG. 1, that may execute applications within the HMD device 200 and receive depth information, position information, acceleration information, velocity information, predicted future positions, or any combination thereof of the HMD device 200 from the various sensors.

In some examples, the information received by the virtual reality engine 116 may be used for producing a signal (e.g., display instructions) to the one or more display assemblies. In some examples, the HMD device 200 may include locators (not shown), but similar to the virtual locators 126 described in FIG. 1, which may be located in fixed positions on the body 220 of the HMD device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user’s eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 3 is a perspective view of a near-eye display 300 in the form of a pair of glasses (or other similar eyewear), according to an example. In some examples, the near-eye display 300 may be a specific implementation of near-eye display 120 of FIG. 1, and may be configured to operate as a virtual reality display, an augmented reality display, and/or a mixed reality display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display 300, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

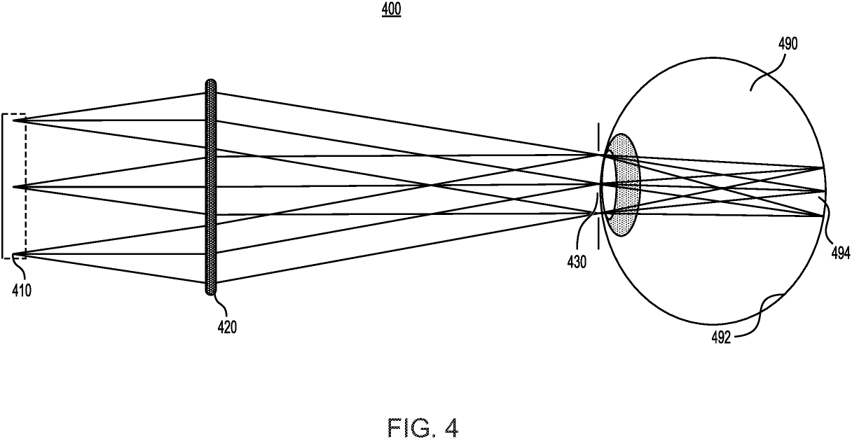

FIG. 4 illustrates a schematic diagram of an optical system 400 in a near-eye display system, according to an example. In some examples, the optical system 400 may include an image source 410 and any number of projector optics 420 (which may include waveguides having gratings as discussed herein). In the example shown in FIG. 4, the image source 410 may be positioned in front of the projector optics 420 and may project light toward the projector optics 420. In some examples, the image source 410 may be located outside of the field of view (FOV) of a user’s eye 490. In this case, the projector optics 420 may include one or more reflectors, refractors, or directional couplers that may deflect light from the image source 410 that is outside of the field of view (FOV) of the user’s eye 490 to make the image source 410 appear to be in front of the user’s eye 490. Light from an area (e.g., a pixel or a light emitting device) on the image source 410 may be collimated and directed to an exit pupil 430 by the projector optics 420. Thus, objects at different spatial locations on the image source 410 may appear to be objects far away from the user’s eye 490 in different viewing angles (i.e., fields of view (FOV)). The collimated light from different viewing angles may then be focused by the lens of the user’s eye 490 onto different locations on retina 492 of the user’s eye 490. For example, at least some portions of the light may be focused on a fovea 494 on the retina 492. Collimated light rays from an area on the image source 410 and incident on the user’s eye 490 from a same direction may be focused onto a same location on the retina 492. As such, a single image of the image source 410 may be formed on the retina 492.

In some instances, a user experience of using an artificial reality system may depend on several characteristics of the optical system, including field of view (FOV), image quality (e.g., angular resolution), size of the eyebox (to accommodate for eye and head movements), and brightness of the light (or contrast) within the eyebox. Also, in some examples, to create a fully immersive visual environment, a large field of view (FOV) may be desirable because a large field of view (FOV) (e.g., greater than about 60°) may provide a sense of “being in” an image, rather than merely viewing the image. In some instances, smaller fields of view may also preclude some important visual information. For example, a head-mounted display (HMD) system with a small field of view (FOV) may use a gesture interface, but users may not readily see their hands in the small field of view (FOV) to be sure that they are using the correct motions or movements. On the other hand, wider fields of view may require larger displays or optical systems, which may influence the size, weight, cost, and/or comfort of the head-mounted display (HMD) itself.

In some examples, a waveguide may be utilized to couple light into and/or out of a display system. In particular, in some examples and as described further below, light of projected images may be coupled into or out of the waveguide using any number of reflective or diffractive optical elements, such as gratings. For example, as described further below, one or more volume Bragg gratings (VBG) may be utilized in a waveguide-based, back-mounted display system (e.g., a pair of glasses or similar eyewear).

In some examples, one or more volume Bragg gratings (VBGs) (or two portions of a same grating) may be used to diffract display light from a projector to a user’s eye. Furthermore, in some examples, the one or more volume Bragg gratings (VBGs) may also help compensate for any dispersion of display light caused by each other to reduce the overall dispersion in a waveguide-based display system.

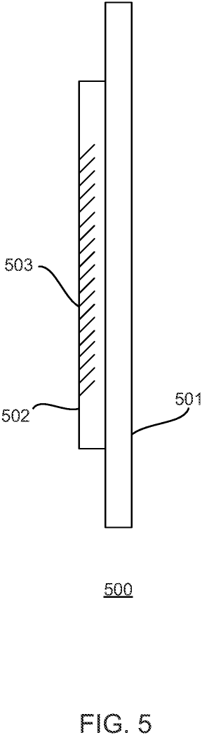

FIG. 5 illustrates a diagram of a waveguide 500, according to an example. In some examples, the waveguide 500 may include a plurality of layers, such as at least one substrate 501 and at least one photopolymer layer 502. In some examples, the substrate 501 may be a comprised of a polymer, glass, crystal, ceramic, and/or other similar material. In some examples, the photopolymer layer 502 may be transparent or “see-through”, and may include any number of photosensitive materials (e.g., a photo-thermo-refractive glass) or other similar material.

In some examples, the at least one substrate 501 and the at least one photopolymer layer 502 may be optically bonded (e.g., glued on top of each other) to form the waveguide 500. In some examples, the substrate 501 may have a thickness of anywhere between around 0.4-0.6 millimeters (mm) or other thickness range. In some examples, the photopolymer layer 502 may be a film layer having a thickness of anywhere between about 10-800 micrometers (µm) or other range.

In some examples, one or more volume Bragg gratings (VBGs) may be provided in (or exposed into) the photopolymer layer 502. That is, in some examples, the one or more volume Bragg gratings may be exposed by generating an interference pattern 503 into the photopolymer layer 502. In some examples, the interference pattern 503 may be generated by superimposing two lasers to create a spatial modulation that may generate the interference pattern 503 in and/or throughout the photopolymer layer 502. In some examples, the interference pattern 503 may be a sinusoidal pattern. Also, in some examples, the interference pattern 503 may be made permanent via a chemical, optical, mechanical, or other similar process.

By exposing the interference pattern 503 into the photopolymer layer 502, for example, the refractive index of the photopolymer layer 502 may be altered and a volume Bragg grating may be provided in the photopolymer layer 502. Indeed, in some examples, a plurality of volume Bragg gratings or one or more sets of volume Bragg gratings may be exposed in the photopolymer layer 502. It should be appreciated that this technique may be referred to as “multiplexing.” It should also be appreciated that other various techniques to provide a volume Bragg grating (VBG) in or on the photopolymer layer 502 may also be provided.

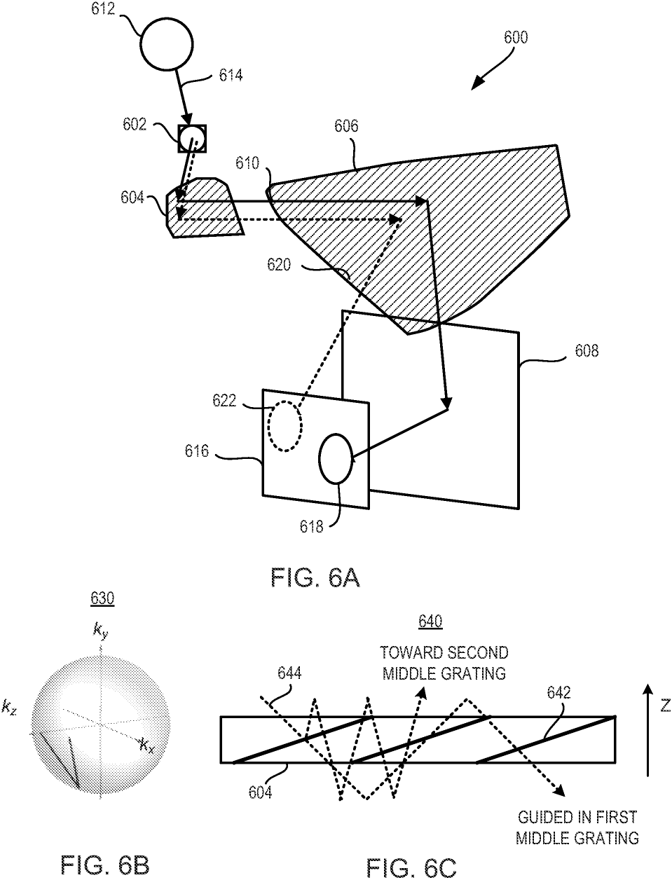

FIG. 6A illustrates a diagram of a waveguide configuration 600 including an arrangement of volume Bragg gratings (VBGs), according to an example. In some examples, the waveguide configuration 600 may be used in a display system, similar to the near-eye display system 300 of FIG. 3. The waveguide configuration 600, as shown, may include an input volume Bragg grating (VBG) 602 (“input grating” or “IG”), a first middle volume Bragg grating (VBG) 604 (“first middle grating” or “MG1”), a second middle volume Bragg grating (VBG) 606 (“second middle grating” or “MG2”), and an output volume Bragg grating (VBG) 608 (“output grating” or “OG”).

In some examples, a projector 612 of the display system may transmit display light 614 to the arrangement of volume Bragg gratings (VBGs) 602-608 in the waveguide configuration 600. As shown, the projector 612 may output the display light 614 to the input grating 602. The input grating 602 may include a grating configuration that may propagate the display light 614 received from the projector 612 to the first middle grating 604. The first middle grating 604 may include a grating configuration that may propagate the received display light 614 to the second middle grating 606. The second middle grating 606 may include a grating configuration that may propagate the display light 614 to the output grating 608. The output grating 608 may include a grating configuration that may propagate the received display light 614 to an eyebox 616 or a user’s eye (not shown). The display light 614 may be associated with an image 618 that may be displayed on the eyebox 616 or that a user may otherwise see the image 618.

Each of the input grating 602, the first middle grating 604, the second middle grating 606, and the output grating 608 may include grating configurations to cause received light to be propagated, e.g., refracted, diffracted, and/or reflected, into certain directions as shown by the arrows 610. It should be understood that the arrows 610 depicted in FIG. 6A may represent a plurality of light rays that may, for instance, expand as the light rays are propagated from the input grating 602, the first middle grating 604, the second middle grating 606, and the output grating 608.

As discussed above, the waveguide configuration 600 may include any number of volume Bragg gratings (VBGs) that may be exposed into a “see-through” photopolymer material. In this way, the entire waveguide configuration 600 may be relatively transparent so that a user may see through to the other side of the waveguide configuration 600. At the same time, the waveguide configuration 600, with its arrangement of volume Bragg gratings 602-608, may (among other things) receive the propagated display light 614 from the projector 612 and may cause the propagated display light 614 to be displayed as an image 618 in front of a user’s eyes for viewing. For instance, the waveguide configuration 600 may cause an image 618 corresponding to the display light 614 to be displayed on the eyebox 616. In this way, any number of augmented reality (AR) and/or mixed reality (MR) environments may be provided to and experienced by the user.

In some examples, the input grating 602 and the output grating 608 may have the same grating vector with respect to each other. Additionally, the first middle grating 604 and the second middle grating 606 may have the same grating vector with respect to each other. As a result, dispersion of light propagated through the input grating 602, the first middle grating 604, the second middle grating 606, and the output grating 208 may cancel. In order to incorporate an intended range of field of view and spectrum, each of the gratings 602-608 may contain multiplex grating pitches to support the intended range of field of view and spectrum. In some instances, crosstalk, which is represented as a dashed arrow 620 in FIG. 6A, may occur between some of the multiplex gratings 602-608. A result of the crosstalk 620 may be that display of a ghost image 622 on the eyebox 616 or is otherwise viewable by a user may be induced. A ghost image 622 may be defined as any undesired image appearing on the eyebox 616 or is otherwise viewable by a user. For instance, a ghost image 622 may be a false image version of the image 618, an out-of-focus version of the image 618, a distorted version of the image 618, a misdirected version of the image 618, and/or the like.

FIG. 6B shows a k-vector diagram 630 corresponding to the propagation of light through the first middle grating 604 and the second middle grating 606 depicted in FIG. 6A. FIG. 6C shows an enlarged cross-sectional view of a portion 640 of the first middle grating 604 depicted in FIG. 6A. Particularly, the portion 640 shown in FIG. 6C depicts a representation of a z-direction grating configuration 642 within the first middle grating 604 according to an example. As shown, the grating configuration 642 may have a particular angle such that light rays, as represented by the arrows 644, may be propagated through the first middle grating 604 in a certain manner such that the light rays may be outputted toward the second middle grating 606 in a certain direction while being guided in the first middle grating 604. The output of the light rays in the manner shown in FIG. 6C may result in the appearance of a ghost image 622 on the eyebox 616 as shown in FIG. 6A, for instance, due to crosstalk as discussed herein.

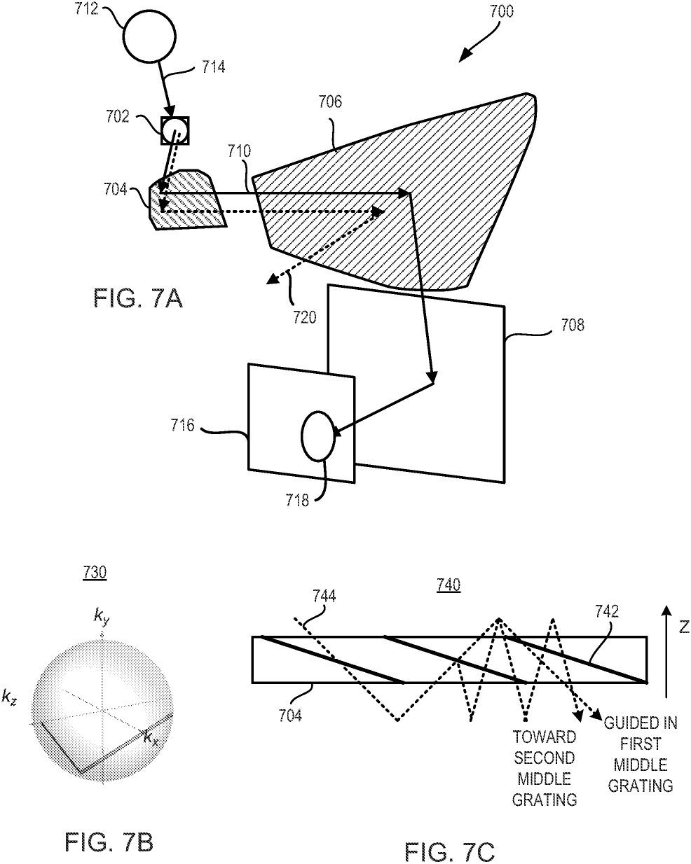

Reference is now made to FIG. 7A, which depicts a diagram of a waveguide configuration 700 including an arrangement of volume Bragg gratings (VBGs), according to an example. Similarly, to the waveguide configuration 600 depicted in FIG. 6A, the waveguide configuration 700 may be used in a display system, similar to the near-eye display system 300 of FIG. 3. The waveguide configuration 700 may include an input volume Bragg grating (VBG) 702 (“input grating” or “IG”), a first middle volume Bragg grating (VBG) 704 (“first middle grating” or “MG1”), a second middle volume Bragg grating (VBG) 706 (“second middle grating” or “MG2”), and an output volume Bragg grating (VBG) 708 (“output grating” or “OG”). Each of the input grating 702, the first middle grating 704, the second middle grating 706, and the output grating 708 may include grating configurations to cause received light to be propagated, e.g., refracted, diffracted, and/or reflected, into certain directions as shown by the arrows 710.

According to examples, at least one of the gratings 702-708 in the waveguide configuration 700 may be oriented to reduce (e.g., prevent or minimize) a ghost image 622 from being displayed on an eyebox 716. For instance, at least one of the gratings 702-708 may be oriented to cause a display light 714 from a light source 712 to be directed to a predefined direction that causes the appearance of the ghost image 622 to be reduced on the eyebox 716. By way of example, a z-direction of the first middle grating 704 may be oriented to cause the display light 714, which may include light propagated through crosstalk 720 among some of the gratings 702-708, to be directed to a predefined z-direction that causes the appearance of the ghost image 622 on the eyebox 716 to be reduced. For instance, the crosstalk 720 may be directed in a direction that does not lead to the eyebox 716. Instead, an intended image 718 may be displayed on the eyebox 716 without the appearance of the ghost image of the intended image 718.

Reference is now made to FIG. 7B, which shows a k-vector diagram 730 corresponding to the propagation of light through the first middle grating 704 and the second middle grating 706 depicted in FIG. 7A. In comparing the k-vector diagram 730 with the k-vector diagram 630, it may be seen that the k-vector differs in the z-direction. The k-vector diagrams 630 and 730 also show that the dispersions are conserved, e.g., that the k-vectors are conserved between the configurations shown in FIGS. 7A and 7B. Particularly, for instance, the k-vectors may be conserved by having the same grating vector Ka in both the input grating 602 and the output grating 608 and having the same grating vector Kb in the first middle grating 604 and the second middle grating 606. In the waveguide configuration 700, Kb becomes Kb′, which means that the grating vector of the first middle grating 604 and the second middle grating 606 both adjust to Kb′ in the waveguide configuration 700. Because the grating vector of the first middle grating 704 is still the same as grating vector of the second middle grating 706 in the waveguide configuration 700, the k-vector of the incident light 714 and exiting light reaching 718 are still conserved.

The k-vector diagrams 630 and 730 respectively show the k-vector conservations of the waveguide configurations 600, 700. Particularly, the ray vector first enters the input grating 602, 702 at (0,0,1) where kx=ky=0 and kz=1. The ray vector then follows Ka and reaches k2 (the Ka of the input grating 602, 702. The ray vector then follows Kb to reach k3 (the kb of the first middle grating 604) or Kb′ to reach k3 (the kb′ of the first middle grating 702). It should be noted that k1, k2, and k3 are the three intercepts shown on the k-vector diagrams 630, 730. As light propagates at k3 and reaches the second middle grating 606, 706, wherein the light may experience -Kb or-Kb′, thus going back to direction k2 and reaches the output grating 608, 708. As the output grating 608, 708 provides -Ka, the ray direction becomes k1, which is the same as the incident direction at which the input grating 602, 702 propagated the light. As a result, dispersion is zero or, similarly, conserved.

In the discussion above, Kb is designed to cover the required FOV and spectrum while maintaining a small grating region. Flipping the Kb z-component as described herein does not change the FOV and the spectrum coverage while maintaining the same grating size. This may also result in the reduction of the ghost image path 620 as discussed herein.

FIG. 7C shows an enlarged cross-sectional view of a portion 740 of the first middle grating 704 depicted in FIG. 7A. Particularly, the portion 740 shown in FIG. 7C depicts a representation of a z-direction grating configuration 742 within the first middle grating 704 according to an example. As shown, the grating configuration 742 may have a particular angle such that light rays, as represented by the arrows 744, may be propagated through the first middle grating 704 in a certain manner such that the light rays may be outputted toward the second middle grating 706 in a certain direction while being guided in the first middle grating 704. The output of the light rays in the manner shown in FIG. 7C may result in a reduction (e.g., minimization or prevention) in the appearance of a ghost image 622 on the eyebox 716.

In comparing FIGS. 6C and 7C, it may be seen that the z-direction of the gratings 742 shown in the portion 740 is opposite the z-direction of the gratings 642 shown in the portion 640. In other words, the z-direction of the gratings 642 may be construed as a normal z-direction and the z-direction of the gratings 742 may be opposite to the normal z-direction. By way of particular example in which the normal z-direction is N, the z-direction of the gratings 742 may be -N. Likewise, in a particular example in which the normal z-direction of the gratings 642 is -N, the z-direction of the gratings 742 may be N. In one regard, and as shown in FIGS. 6C and 7C, the light rays 644, 744 may be guided in the first middle grating 604, 704 in the same z-directions. However, the light rays 644, 744 may be directed in different z-directions toward the second middle gratings 606, 706. As a result, the image 718 may still appear on the eyebox 716 as intended, but the appearance of a ghost image of the image 718 on the eyebox 716 may be reduced, e.g., prevented or minimized.

Although particular reference has been made herein to the z-direction of the grating configuration 742 in the first middle grating 704 as being opposite to the normal z-direction of the grating configuration 642 in the first middle grating 604, it should be understood that the z-directions of the grating configurations in one or more of the other ones of the gratings 702, 706, 708 may alternatively or additionally be configured to reduce the appearance of a ghost image on the eyebox 716. For instance, the z-direction of the grating configuration in the second middle grating 706 may similarly or alternatively be oriented to be opposite that of the z-direction of the grating configuration in the second middle grating 606. In other words, either or both of the first middle grating 704 and the second middle grating 706 may have grating 742 configurations that may reduce the appearance of the ghost image on the eyebox 716. In some examples, the grating 742 configuration of either or both of the first middle grating 704 and the second middle grating 706 may be determined through testing, modeling, historical data, and/or the like. In some examples, the z-directions of the both the first middle grating 704 and the second middle grating 706 may be oriented to the same direction.

In some examples, the volume Bragg gratings 702-708 may be patterned (e.g., using sinusoidal patterning) into and/or on a surface of the photopolymer material. Accordingly, in some examples and in this manner, the volume Bragg gratings (VBG) 702-708 may receive and direct propagated light 714 for viewing by a user. In addition, in some examples, the volume Bragg gratings (VBG) 702-708 may be implemented to “expand” (i.e., horizontally and/or vertically) a region in space to be viewed so that a user may view a displayed image 718 regardless of where a pupil of a user’s eye may be. As such, in some examples, by expanding this viewing region, the volume Bragg gratings (VBG) 702-708 may ensure that a user may move their eye in various directions and still view the displayed image 718.

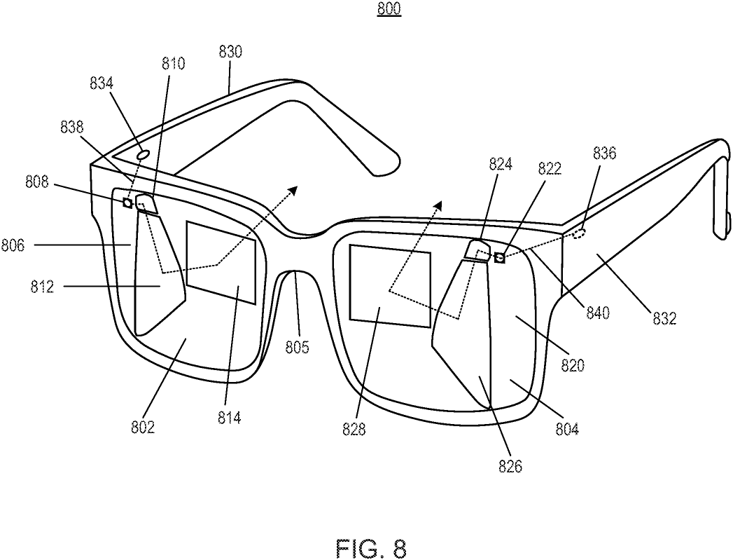

FIG. 8 illustrates a diagram of a back-mounted arrangement for a display system 800 in a shape of eyeglasses, according to an example. In some examples, the display system 800 may include a first lens assembly 802 and a second lens assembly 804. As shown, a bridge 805 may couple the first lens assembly 802 and the second lens assembly 804. Each of the lens assemblies 802, 804 may include waveguide configurations that are equivalent to the waveguide configuration 700 depicted in FIG. 7A. For instance, the first lens assembly 802 may include a waveguide configuration 806 that may include an input grating 808, a first middle grating 810, a second middle grating 812, and an output grating 814. Although not shown, the first lens assembly 802 may include an eyebox 716 positioned behind the output grating 814. For instance, the waveguide configuration 806 may be formed in a first photopolymer layer and the eyebox 716 may be formed in a second photopolymer layer that is adjacent to the first photopolymer layer.

In addition, the second lens assembly 804 may include a waveguide configuration 820 that may include an input grating 822, a first middle grating 824, a second middle grating 826, and an output grating 828. The second lens assembly 804 may also include an eyebox 716 positioned behind the output grating 828. For instance, the waveguide configuration 820 may be formed in a first photopolymer layer and the eyebox 716 may be formed in a second photopolymer layer that is adjacent to the first photopolymer layer.

According to examples, each of the first middle gratings 810, 824 in the first lens assembly 802 and the second lens assembly 804 may respectively include grating configurations that are similar to the grating configurations 742 shown in FIG. 7C. In this regard, the first lens assembly 802 may cause a first image to be viewable by a user’s right eye while an appearance of a ghost image of the first image is reduced. In addition, the second lens assembly 804 may cause a second image to be viewable by a user’s left eye while an appearance of a ghost image of the second image is reduced.

As shown in FIG. 8, the display system 800 may include a first temple arm 830 that may be positioned next to a user’s right temple when the display system 800 is positioned with respect to the user’s eyes. The display system 800 may also include a second temple arm 832 that may be positioned to the user’s left temple when the display system 800 is positioned with respect to the user’s eyes. A first projector 834 may be positioned near or on the first temple arm 830 and a second projector 836 may be positioned near or on the second temple arm 832. Each of the first projector 834 and the second projector 836 may be similar to the light source 712 (e.g., projector 712) depicted in FIG. 7. In this regard, the first projector 834 may be positioned and configured to direct display light 838 from the first projector 834 into the input grating 808 such that the display light 838 corresponding to a first image may be propagated through the gratings 808-814 to be displayed on, for instance, an eyebox of the first lens assembly 802. Likewise, the second projector 836 may be positioned and configured to direct display light 840 into the input grating 822 such that the display light 840 corresponding to a second image may be propagated through the gratings 822-828 to be displayed, for instance, on an eyebox of the second lens assembly 804.

Accordingly, in some examples, the first lens assembly 802 and the second lens assembly 804 may present a first image and a second image, respectively, to be viewed by a user’s respective eye, when wearing the display system 800, to generate a simultaneous, “binocular” viewing. That is, in some examples, the first image projected by the first lens assembly 802 and the second image projected on the second lens assembly 804 may be uniformly and symmetrically “merged” to create a binocular visual effect for a user of the display system 800. In other examples, one of the first lens assembly 802 or the second lens assembly 804 may be omitted from the display system 800 such that a monocular viewing is provided to a user of the display system 800

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A display system, comprising:
a wearable eyewear arrangement, comprising:
a lens assembly comprising:
a projector to propagate display light associated with an image; and
a waveguide for propagating the display light to an eyebox, wherein the first waveguide comprises a plurality of gratings through which the display light is sequentially propagated and wherein at least one of the plurality of gratings is oriented to propagate the display light to a next grating of the plurality of gratings while reducing an appearance of a ghost image of the image on the eyebox.

2. The display system of claim 1, wherein each of the plurality of gratings comprises multiplex grating pitches.

3. The display system of claim 2, wherein a z-direction of the at least one of the plurality of gratings is oriented to cause the first display light to be directed to a predefined z-direction that causes the appearance of the ghost image on the eyebox to be reduced.

4. The display system of claim 3, wherein the z-direction of the at least one of the plurality of gratings comprises a direction that is opposite a normal z-direction of the at least one of the plurality of gratings.

5. The display system of claim 1, wherein the plurality of gratings comprise:
an input grating;
a first middle grating;
a second middle grating; and
an output grating, wherein the first display light is to sequentially propagate through the input grating, the first middle grating, the second middle grating, and the output grating to the eyebox.

6. The display system of claim 5, wherein the at least one of the plurality of gratings comprises the first middle grating, the second middle grating, or both the first middle grating and the second middle grating.

7. The display system of claim 1, wherein the wearable eyewear arrangement further comprises:
another lens assembly comprising:
another projector to propagate another display light associated with another image; and
another waveguide for propagating the other image to another eyebox, wherein the other waveguide includes a plurality of gratings through which the other display light is sequentially propagated and wherein at least one of the plurality of gratings in the other waveguide is oriented to propagate the other display light to a next grating while reducing an appearance of a ghost image of the other image on the another eyebox.

8. The display system of claim 1, wherein each of the plurality of gratings comprises a volume Bragg grating.

9. The display system of claim 7, wherein a z-direction of the at least one of the plurality of gratings in the second waveguide is oriented to cause the second display light to be directed to a predefined z-direction that causes the appearance of the ghost image on the another eyebox to be reduced.

10. The display system of claim 7, wherein the wearable eyewear arrangement comprises:
a first temple arm, wherein the first projector is located near or on the first temple arm; and
a second temple arm, wherein the second projector is located near or on the second temple arm.

11. An apparatus comprising:
a first lens assembly comprising:
a first waveguide to propagate a first display light associated with a first image from a first projector, the first waveguide including:
an input grating;
a first middle grating; and
an output grating, wherein the input grating is to receive the first display light from the first projector and to direct the received first display light to the first middle grating, and the first middle grating is to direct the first display light toward the output grating while reducing an appearance of a ghost image of the first image on a first eyebox; and
a second lens assembly connected to the first lens assembly.

12. The apparatus of claim 11, wherein each of the input grating, the first middle grating, and the output grating comprises multiplex grating pitches and wherein a z-direction of the first middle grating is oriented to cause the first display light to be directed to a predefined z-direction that causes the appearance of the ghost image on the first eyebox to be reduced.

13. The apparatus of claim 12, wherein the z-direction of the first middle grating comprises a direction that is opposite a normal z-direction of the first middle grating.

14. The apparatus of claim 11, wherein the second lens assembly comprises:
a second waveguide for propagating a second image to a second eyebox, wherein the second waveguide includes a plurality of gratings through which the second display light is sequentially propagated and wherein at least one of the plurality of gratings in the second waveguide is oriented to propagate the second display light to a next grating while reducing an appearance of a ghost image of the second image on the second eyebox.

15. The apparatus of claim 14, wherein a z-direction of the at least one of the plurality of gratings in the second waveguide is oriented to cause the second display light to be directed to a predefined z-direction that causes the appearance of the ghost image on the second eyebox to be reduced.

16. A wearable eyewear comprising:
a first lens assembly; and
a second lens assembly connected to the first lens assembly,
wherein each of the first lens assembly and the second lens assembly comprises:
a waveguide for propagating a display light of an image to an eyebox, wherein the waveguide includes a plurality of gratings having orientations that cause the display light to be propagated sequentially through the plurality of gratings, and wherein at least one of the plurality of gratings is oriented to propagate the display light to a next grating while reducing an appearance of a ghost image of the image on the eyebox.

17. The wearable eyewear of claim 16, wherein the waveguides of each of the first lens assembly and the second lens assembly comprises:
an input grating;
a first middle grating;
a second middle grating; and
an output grating, wherein the input grating is to receive the display light from a projector and to direct the received display light to the first middle grating, the first middle grating is to direct the display light to the second middle grating, the second middle grating is to direct the display light to the output grating, and the output grating is to direct the display light to the eyebox.

18. The wearable eyewear of claim 17, wherein each of the input grating, the first middle grating, the second middle grating, and the output grating comprises multiplex grating pitches and wherein a z-direction of the first middle grating, the second middle grating, or both the first middle grating and the second middle grating is oriented to cause the display light to be directed to a predefined z-direction that causes the appearance of the ghost image on the eyebox to be reduced.

19. The wearable eyewear of claim 17, further comprising:
a first light source to project the display light onto the input grating of the first lens assembly; and
a second light source to project the display light onto the input grating of the second lens assembly.

20. The wearable eyewear of claim 19, further comprising:
a first temple arm, wherein the first light source is located near or on the first temple arm; and
a second temple arm, wherein the second light source is located near or on the second temple arm.
